(19) United States
(12) Patent Application Publication
(10) Pub. No.: US 2010/0060208 A1
(43) Pub. Date: Mar. 11, 2010

(54) Quarter-Wave-Stub Resonant Coupler

(76) Inventor: Donald A. Swenson, Albuquerque, NM (US)

Correspondence Address: DENNIS F ARMIJO;DENNIS F. ARMIJO, P.C., 6300 MONTANO RD. NW, SUITE D, ALBUQUERQUE, NM, 87120, US

(21) Appl. No.: 12/550,526

(22) Filed: Aug. 31, 2009

Related U.S. Application Data
(60) Provisional application No. 61/095,446, filed on Sep. 9, 2008.

(51) Int. Cl. H05H 9/00

(52) U.S. Cl. 315/505; 313/360.1

(57) ABSTRACT

A linac system having at least two linac structures configured to operate with a resonant coupler. The linac structures and the resonant coupler resonate at the same frequency, are in close proximity, and designed for a relative phase of 0° or 180°. The coupling between the resonant coupler and the linac structures is achieved by slots between the linac structures and the resonant coupler, which allow the magnetic fields of the linac structures to interact with the magnetic field of the resonant coupler. The relative size of the slots determines the relative amplitude of the fields in the linac structures. There are three modes of oscillation, a 0 mode, wherein the linac structures and the resonant coupler are excited in phase, a π/2 mode, wherein the linac structures are excited out of phase and the resonant coupler is nominally unexcited, and the π mode, wherein the linac structures and the resonator coupler are excited out of phase.

### RELATED APPLICATIONS

This application is related to U.S. Provisional Patent Application Ser. No. 61/095,446 entitled “Quarter-Wave-Stub Resonant Coupler”, filed on Sep. 9, 2008, the teachings of which are incorporated herein by reference.

### BACKGROUND OF THE INVENTION

1. Field of the Invention (Technical Field)

The presently claimed invention relates to particle accelerators and more particularly to a device, which when coupled to two electromagnetic resonators, provides exceptional control of the relative amplitude and relative phase of the electromagnetic fields in the two resonators.

2. Background Art

Most particle accelerators employ electromagnetic resonators to produce high electric fields that can be used to accelerate charged particles to higher energies. Linear accelerators, such as linacs, involve resonant cavities where radio frequency (RF) power is transformed into a distribution of RF electric fields that can be used to accelerate charged particles. Particle accelerators involving a single resonator have a requirement that the amplitude of the fields in the resonator be appropriate for the acceleration process. Particle accelerators involving two or more resonators have an additional requirement that the relative phase of the fields in adjacent resonators be controlled. The problem is particularly acute in linac systems involving two or more independent linac structures. Control of the relative phase of the fields requires that the frequency of the electromagnetic excitations in all the resonators be the same or harmonically related. Such linacs typically start out with a short Radio Frequency Quadrupole (RFQ) linac structure followed by a different linac structure with higher acceleration efficiencies. The typical approach today, for linac systems composed of two different linac structures, is to drive each linac structure with its own RF power source and to control the amplitude and phase of the fields in the cavities by active, electronic control techniques. This requires two RF power systems, each with circuitry to control the amplitude and phase of the fields in each linac structure. In addition, this approach requires active control of the resonant frequencies of the two linac structures. This requires controlling the RF of all resonators to the required accuracy, to control the amplitude of the fields in all resonators to the required accuracy, and to control the phase of RF fields in all cavities to some phase reference to the required accuracy. The problem with these prior art systems is that these systems are extremely complicated.

There are several prior art publications that disclose resonant coupling of a large number of similar cells (resonators) into a linac structure. These prior art patents are U.S. Pat. No. 3,501,734, entitled “Method and Device for Stabilization of the Field Distribution in Drift Tube Linac”; U.S. Pat. No. 3,953,758, entitled “Multiperiodic Linear Accelerating Structure”; U.S. Pat. No. 4,155,027, entitled “S-Band Standing Wave Accelerator Structure with On-Axis Coupling”; U.S. Pat. No. 4,988,919, entitled “Small-Diameter Standing-Wave Linear Accelerating Structure”; and U.S. Pat. No. 5,578,909, entitled “Coupled-Cavity Drift-Tube Linac”. These prior art patents teach resonantly coupled multicell linac structures. Each of these structures has a large number of accelerating cells interspersed with a large number of coupling cells. When operated in the π/2 cavity mode, relative excitation of the accelerating cells is very well defined, the phase of the fields in the adjacent accelerating cells are exactly “out of phase”, and the coupling cells are nominally unexcited. These are important features of these linac structures, as well as the coupled linac structures of the presently claimed invention. The presently claimed invention; however, addresses the coupling of two different linac structures into a single resonant unit with a single resonant coupler, which is unique and not taught by the prior art. This invention serves to couple two otherwise independent linac structures into one resonant unit where the relative amplitude and relative phase of the fields in the two structures are precisely controlled by the geometry of the resonantly coupled configuration. This solution simplifies the aforementioned problems of the prior art and provides a relatively inexpensive solution.

### SUMMARY OF THE INVENTION

### Disclosure of the Invention

The presently claimed invention greatly simplifies the control problem for two-resonator particle accelerators. The resonant coupler provides a single frequency at which the pair of resonators can be excited, even when the resonant frequencies of the individual resonators are not identical. The resonant coupler locks the relative amplitudes and relative phases of the field in the two resonators. Consequently, the presently claimed invention reduces the control problem for two-resonator accelerators to that of controlling the frequency of the drive power to the single frequency offered by the resonant coupler and controlling the amplitude of either resonator to the required accuracy. The two linac structures and the resonant coupler must be designed to resonate at the same frequency. The resonant coupler requires that the two linac structures be designed to be in close proximity and designed for a relative phase of exactly 0° or 180°. The resonant coupler requires some type of coupling to the fields of the two structures. In the preferred configuration, the coupling is achieved by slots between the linac structures and the resonant coupler, which allow the magnetic fields of the linac structures to interact with the magnetic field of the resonant coupler. The relative size of the slots determines the relative amplitude of the fields in the two linac structures.

The high RF electric fields in the linac structures and the particle beams that traverse them require that the linac structures be evacuated. The coupling of the resonant coupler must not jeopardize the vacuum requirement of the linac structures. The preferred arrangement is to have the linac structures, the resonant coupler, and the coupling slots all under vacuum conditions.

Two-resonator accelerators are common in low energy range of ion accelerators, where the first resonator is the Radio Frequency Quadrupole (RFQ) linear accelerator (linac) structure, with its superb very low energy capabilities, followed by some other low energy linac structure with better acceleration properties. The presently claimed invention offers significant advantages to this important class of low energy ion accelerators.

The presently claimed invention is not restricted to the coupling of particle accelerator resonators. It may find applications in phased-array antennas for radio and microwave transmission, in optical resonators at much higher optical frequencies, in audio resonators at much lower audio frequencies, and in much lower frequency electrical power transmission.

Other objects, advantages and novel features, and further scope of applicability of the presently claimed invention will be set forth in part in the detailed description to follow, taken in conjunction with the accompanying drawings, and in part will become apparent to those skilled in the art upon examination of the following, or may be learned by practice of the claimed invention. The objects and advantages of the claimed invention may be realized and attained by means of the instrumentalities and combinations particularly pointed out in the appended claims.

### BRIEF DESCRIPTION OF THE DRAWINGS

The accompanying drawings, which are incorporated into and from part of the specification, illustrate the embodiment of the presently claimed invention and, together with the description, serve to explain the principles of the claimed invention. The drawings are only for the purpose of illustrating an embodiment of the claimed invention and are not to be construed as limiting the claimed invention. In the drawings:

FIG. 1 is a block diagram of a resonantly coupled pair of generic electromagnetic resonators.

FIG. 2 identifies the symbols used for the depiction of axial electric fields and transverse magnetic fields in simple cylindrical resonators.

FIG. 3A shows an example of magnetic coupling.

FIG. 3B shows an example of electric coupling.

FIG. 4 shows a quarter-wave-stub resonator.

FIG. 5A depicts “0” electromagnetic mode of the resonator configuration.

FIG. 5B depicts “π/2” electromagnetic mode of the resonator configuration.

FIG. 5C depicts “π” electromagnetic mode of the resonator configuration.

FIG. 6 shows a preferred embodiment of a quarter-wave-stub resonator coupled configuration.

FIG. 7 shows an RFQ linac coupled to an RF Focused Interdigital (RFI) linac with the claimed quarter-wave-stub resonant coupler.

FIGS. 8A and 8B show two views of the resonant coupler, one looking downstream showing the RFQ coupling slot, and one looking upstream showing the RFI coupling slot.

FIG. 9 graphically shows the mode spectrum for this resonantly coupled configuration.

FIG. 10 graphically shows the optimal cut out configuration of the cover plate.

FIG. 11 graphically shows the frequency width (0 to π mode) for the optimization of FIG. 10.

### DESCRIPTION OF THE PREFERRED EMBODIMENTS

### Best Modes for Carrying Out the Invention

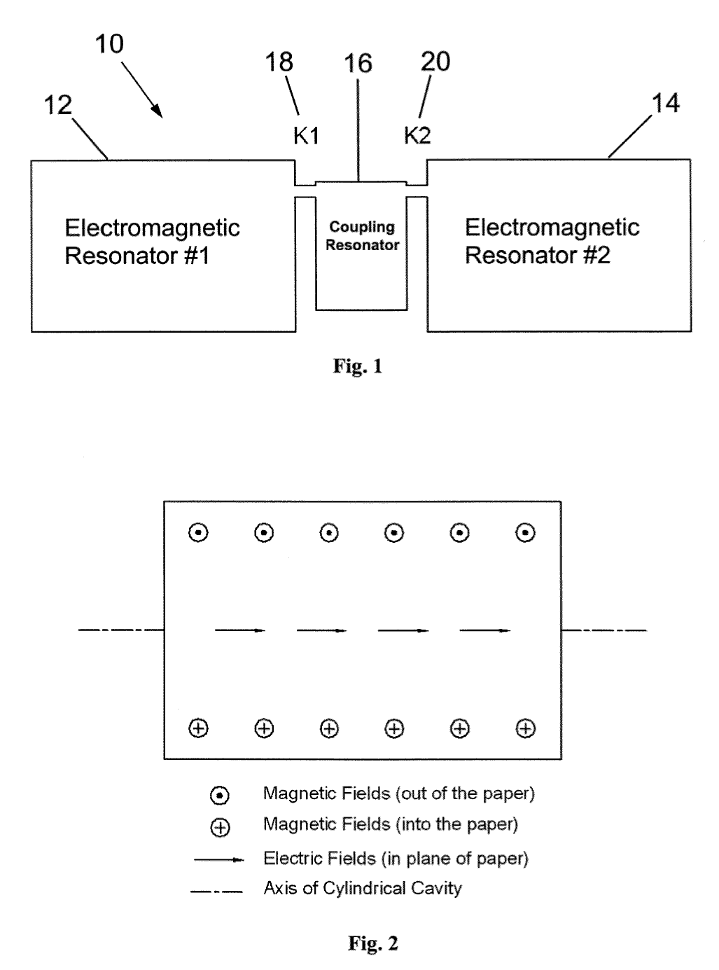

The preferred embodiment of the claimed invention is the resonant coupling of two linac structures of a low energy ion accelerator. Most linac structures have their strongest electric fields on the axis of the linac structure for particle acceleration, and their strongest magnetic fields off the axis near the outer extremities of the linac structure. In the preferred embodiment, the resonant coupler is coupled to the magnetic fields near the ends and outer extremities of the linac structures. FIG. 1 is a block diagram of a resonantly coupled pair of generic electromagnetic resonators 10, resonator 1 12 and resonator 2 14, coupled by a generic coupling resonator 16, where the strength of the coupling to resonator 1 12 is denoted by K1 18 and the strength of the coupling to resonator 2 14 is denoted by K2 20.

FIG. 2 identifies the symbols used for the depiction of axial electric fields and transverse magnetic fields in simple cylindrical resonators.

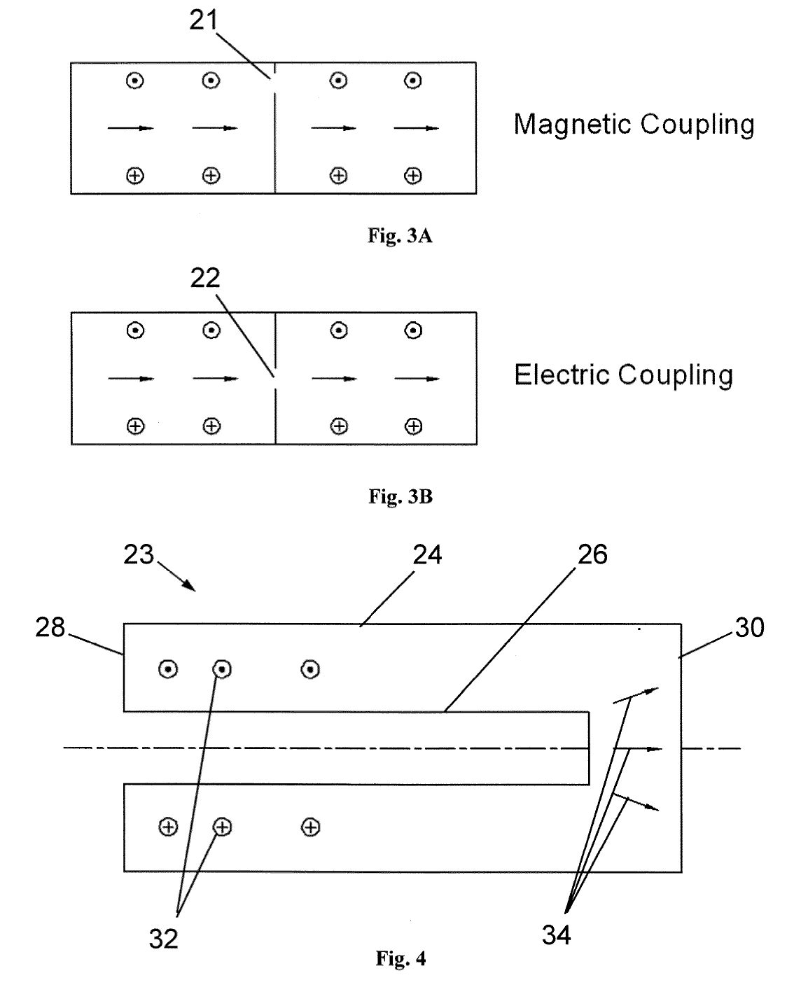

FIG. 3A shows examples of magnetic coupling, where there is an opening (coupling slot) between two adjacent resonators in the vicinity of their magnetic fields, and FIG. 3B shows an example of electric coupling, where there is an opening (coupling slot) between the two adjacent resonators in the vicinity of their electric fields.

FIG. 4 shows a typical quarter-wave-stub resonator 22, where a cylindrical cavity 24 is loaded with a cylindrical post 26, approximately one-quarter wavelength long, connected to a first end 28 and disconnected from a second end 30, which when excited results in the majority of the magnetic fields 32 being close to connected first end 28 and the majority of electric fields 34 being close to disconnected second end 30.

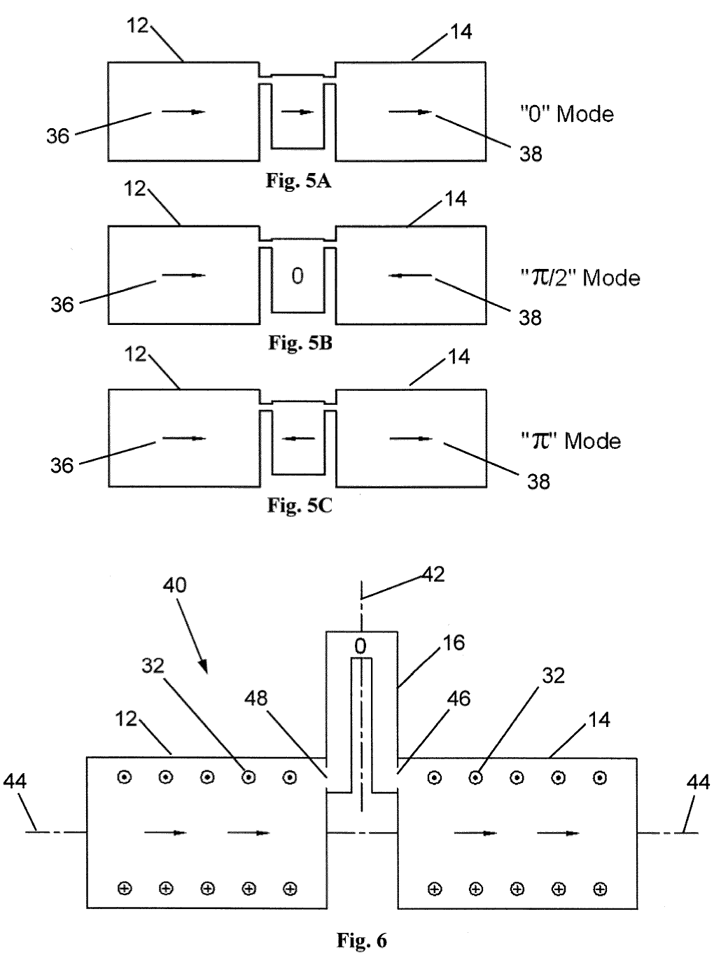

FIGS. 5A, 5B, and 5C depict the properties of the three basic electromagnetic modes of the three resonator configurations of the claimed invention. FIG. 5A shows the “0” mode, where electric fields 36 in resonator 1 12 are “in phase” (same direction) as electric fields 38 in resonator 2 14. FIG. 58 shows the “π” mode, wherein electric fields 36 in resonator 1 12 are π radians) (180° “out of phase” (opposite directions) from electric fields 38 of resonator 2 14. FIG. 5C shows the “π/2” mode wherein resonator 1 12 and resonator 2 14 are excited “out of phase”, as shown by electric fields 36 and 38 and coupling resonator 16 is nominally unexcited.

FIG. 6 shows a preferred embodiment of a quarter-wave-stub resonator coupled configuration 40, where the axis 42 of resonant coupler 16 is normal to the axes 44 of the other two resonators 12 and 14, where openings (coupling slots) 46 and 48 between resonators 12 and 14 are in the vicinity of the magnetic fields 32 of each resonator, and wherein the π/2 mode, resonant coupler 16 is nominally unexcited.

The common linac structures include the Radio Frequency Quadrupole (RFQ) linac, the Drift Tube Linac (DTL), the Side Coupled Linac (SCL), the Disk and Washer (DAW) linac, the RF Focused Interdigital (RFI) linac, and the Alternating Phase Focused Interdigital (APF-IH) linac.

The DTL, SCL, and DAW linac structures employ transverse magnetic (TM) electromagnetic modes, which have strong transverse magnetic fields 32 near the ends and outer extremities of the structure. These linac structures can be coupled with the claimed resonant coupler as shown in FIG. 6.

The RFQ, RFI, and APF-IH linac structures have primarily longitudinal magnetic fields 50 for most of the structure, which turn around at the ends of the structures, resulting in transverse components of their magnetic fields 52 & 53. In the RFQ linac structure, there are four azimuthal locations at each end of the structure that are suitable for magnetic coupling to a resonant coupler. In the RFI and APF-IH linac structures, there is one azimuthal location at the each end of the structures that is suitable for magnetic coupling to a resonant coupler.

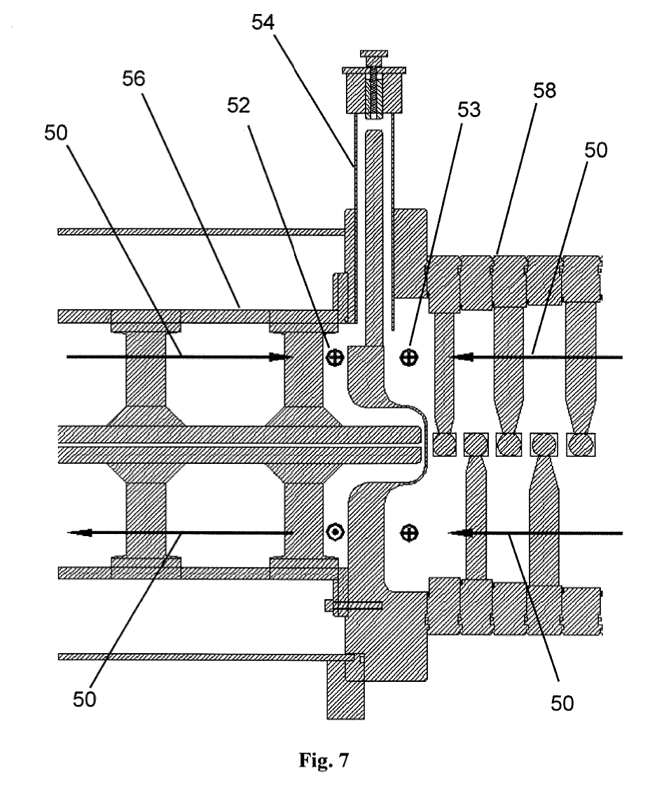

FIG. 7 shows the claimed resonant coupler 54 in a configuration to couple the transverse magnetic fields 52 of an RFQ linac structure 56 to the transverse magnetic fields 53 of an RFI linac structure 58. The longitudinal arrows 50 depict the longitudinal fields of the two structures that lie above the plane of the picture. The longitudinal fields below the plane of the figure are pointed in the opposite direction.

An alternate resonant coupling scheme for the RFQ, RFI, and APF-IH linac structures would be to employ electric coupling to the off-axis electric fields near the ends of these structures.

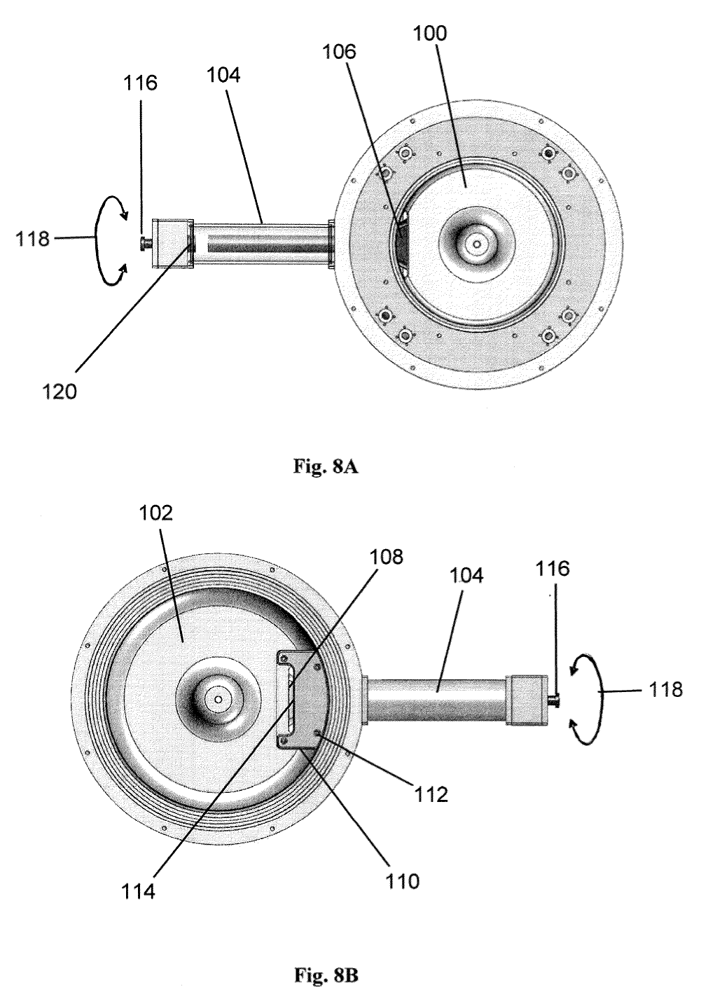

FIG. 8A shows the upstream face of the RFQ/RFI interface plate 100, the claimed resonant coupler 104, and the RFQ coupling slot 106. FIG. 8B shows the downstream face of the RFQ/RFI interface plate 102, the claimed resonant coupler 104, and the RFI coupling slot 108.

FIG. 8B shows a rectangular slot cover plate 110 held in place with four screws 112. Initially, the cover plate 110 was flush on the left (no cut back), which resulted in a very small coupling to the RFI structure. In the course of the adjustment of the ratio of cavity powers in the two accelerating structures, this cover plate was machined to include a cut back 114, as shown.

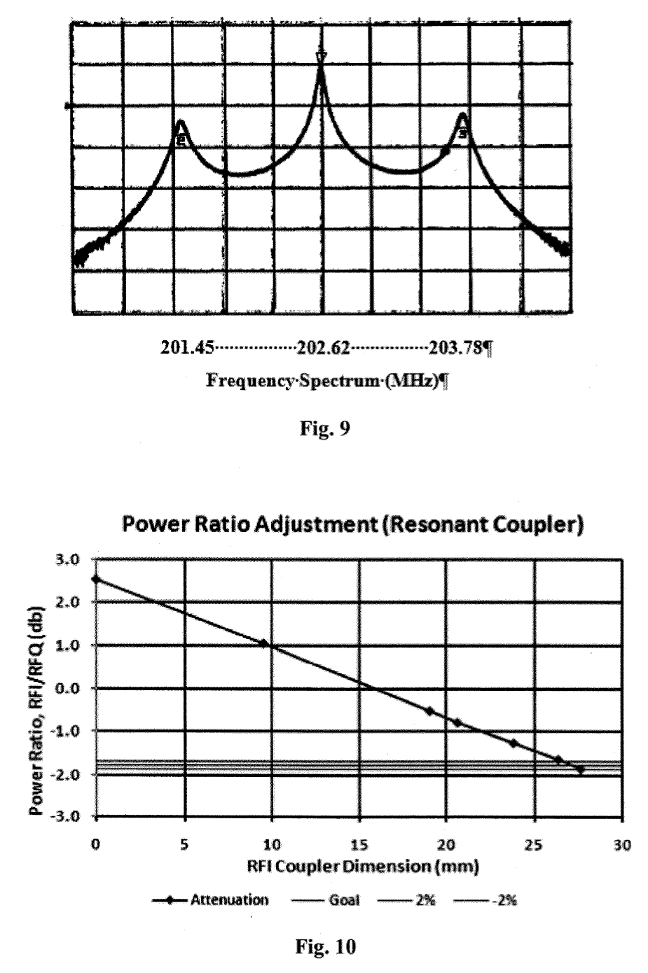

As shown in FIGS. 8A and 8B, a knob 116 at the end of the resonant coupler 104 is rotated 118 to move the tuning slug 120 in and out for adjustment of the resonant frequency of resonant coupler 104. Using knob 116, it is possible to achieve the symmetrical distribution of the three modes (0, π/2 and π) of this three resonator system, as graphically shown in FIG. 9. The total adjustment of resonant coupler 104 requires tuning the resonant coupler via tuning slug 120 to achieve a symmetrical mode spectrum, as shown in FIG. 9, and adjusting one or both coupling slots 106 and 108 to achieve the desired excitation of the two accelerating structures.

The process of adjusting the claimed resonant coupler for an early prototype involving an RFQ linac structure and an RFI linac structure is described here. The required excitation power (P) of the RFQ is based on the calculated power (P_{c}), the calculated quality factor (Q_{c}), and the measured Qₘ, where Q is the ratio of the electromagnetic stored energy in the system to the energy dissipation per radian of the oscillation. For a calculated RFQ power of 46 kW, a calculated Q_{c} of 9500, and a measured Qₘ of 5925, the required excitation power is P_{RFQ}=P_{c}*Q_{c}/Qₘ=73.76 kW. For a calculated RFI power of 32 kW, a calculated Q_{c} of 14942, and a measured Qₘ of 9769, the required excitation power is P_{RFI}=P_{c}*Q_{c}/Qₘ=48.95 kW. The goal is to adjust RFI coupling slot 108 to achieve an RFI to RFQ power ratio, in the π/2 mode, of 48.95/73.76=0.664, or −1.78 db.

With the initial slot cover plate (not shown); the coupling to the RFI structure is small, resulting in a high excitation of the RFI structure. As the cut-back 114 to the slot cover plate 110 is increased, the excitation of the RFI structure decreases, and the ratio of the excitation of the two structures approaches the desired value.

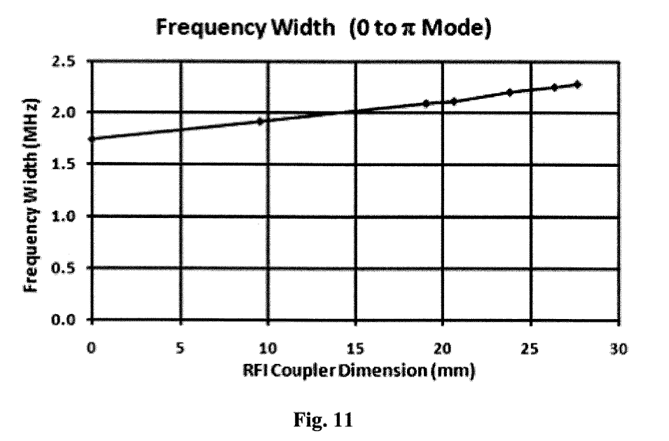

The progress of this power ratio adjustment is shown in FIG. 10. The sloped line on this figure shows the ratio of the RFI to RFQ power (in decibels) as a function of the RFI coupler dimension. The three horizontal lines near the bottom of this figure indicate the desired range for this ratio, centered upon the value of −1.78 db. As the RFI coupler dimension is increased, the RFI/RFQ power ratio decreases and the frequency width (0 to π mode) increases as shown in FIGS. 10 and 11. At the desired RFI/RFQ power ratio, the RFI coupler dimension is 27.62 mm and the frequency width is 2.28 MHz.

The preferred embodiment teaches a configuration of electromagnetic resonators, where the magnetic fields of the resonant coupler are coupled to the magnetic fields of the other two resonators. There are many alternate geometries that will produce the required coupling between the resonant coupler and the other two resonators.

One alternative would be a configuration where the electric field coupling is employed between the resonant coupler and one or both of the other two resonators. Another alternative would be an audio application, where the resonators are audio resonators and the oscillations are acoustical (sound). Yet another alternative would be an optical application, where the resonators are optical resonators and the oscillations are electromagnetic fields in the optical band of frequencies (light). Another alternative would be in the field of electrical power distribution, where the resonators are electrical circuits including lumped inductors and capacitors, operating at power line frequencies.

What is claimed is:

1. A coupler for coupling an electromagnetic field of a first electromagnetic resonator to an electromagnetic field of a second electromagnetic resonator, the coupler comprising a resonant coupler, the resonant coupler further utilizing a coupling mechanism, wherein the resonant coupler and the two electromagnetic resonators are configured to operate in a π/2 cavity mode.

2. The coupler of claim 1 wherein the coupling mechanism comprises coupling slots.

3. The coupler of claim 1 wherein the coupling mechanism comprises coupling loops.

4. The coupler of claim 1 further comprising a frequency tuner.

5. The coupler of claim 4 wherein the frequency tuner comprises a moveable tuning slug.

6. The coupler of claim 1 wherein the resonant coupler and the electromagnetic resonators are all configured to resonate substantially close to a same frequency.

7. The coupler of claim 6 wherein the same frequency comprises a frequency in the range of tens of megahertz (MHz) to tens of gigahertz (GHz).

8. The coupler of claim 1 wherein said resonant coupler has an adjustable coupling to the two electromagnetic resonators for changing a relative amplitude of an electromagnetic field.

9. The coupler of claim 1 further comprising a device for exciting the two electromagnetic resonators, having the same or slightly different resonant frequencies, at a single frequency, where a relative phase and amplitude of electromagnetic fields in the two electromagnetic resonators are locked.

10. The coupler of claim 1 further comprising a next system where a first system of claim 1 is coupled to a second system of claim 1.

11. The coupler of claim 1 wherein the electromagnetic fields comprises a particle accelerator.

12. The coupler of claim 1 wherein the first resonator is an RFQ linac structure and the second resonator is an RFI linac structure.

13. The coupler of claim 1 wherein the first resonator is an RFQ linac structure and the second resonator is a DTL linac structure.

14. A three-resonator configuration comprising a resonant coupler for coupling two electromagnetic resonators that are configured to support three modes of oscillation, which when excited in one of the modes of oscillation, provides propagation of electromagnetic power throughout the three-resonator configuration.

15. The three-resonator configuration of claim 14 wherein the three modes of oscillation comprise a 0 mode, wherein the two electromagnetic resonators and the resonant coupler are excited in phase, a π/2 mode, wherein the two resonators are excited out of phase and the resonant coupler is nominally unexcited, and a π mode, wherein the two electromagnetic resonators and the resonant coupler are excited out of phase.

16. A method for controlling an electromagnetic field of two electromagnetic resonators in a particle accelerator configuration, the method comprising the steps of:
affixing a resonant coupler to the two electromagnetic resonators via coupling mechanisms;
configuring the resonant coupler to the two electromagnetic resonators to operate in a predetermined mode of oscillation;
controlling the relative amplitude and phase of electromagnetic fields of the two electromagnetic resonators by exciting the particle accelerator configuration in the predetermined mode of oscillation.

17. The method of claim 16 wherein the predetermined mode of operation comprises a member consisting of the group of a 0 mode oscillation, a π/2 mode oscillation and a π mode oscillation.

18. The method of claim 17 wherein the step of exciting in the π/2 mode comprises exciting the two electromagnetic resonators out of phase and nominally unexciting the resonant coupler.
